(19) United States
(12) Patent Application Publication
(10) Pub. No.: US 2017/0212904 A1
(43) Pub. Date: Jul. 27, 2017

(54) INFORMATION PROCESSING APPARATUS, INFORMATION PROCESSING METHOD, AND COMPUTER-READABLE STORAGE MEDIUM

(71) Applicant: CANON KABUSHIKI KAISHA, Tokyo (JP)

(72) Inventor: Ken Tokita, Yokohama-shi (JP)

(21) Appl. No.: 15/413,006

(22) Filed: Jan. 23, 2017

(30) Foreign Application Priority Data
Jan. 26, 2016 (JP) 2016-012151

(51) Int. Cl. G06F 17/30; G06F 9/44

(52) U.S. Cl. CPC G06F 17/30112; G06F 9/4443; G06F 17/30312; G06F 17/30864

(57) ABSTRACT

An information processing apparatus includes a memory that stores a computer program, and at least one processor that executes the computer program to perform processing, wherein the processing includes determining whether elapsed time is greater than or equal to a predetermined threshold, wherein the elapsed time is time after a first application that displays content is selected as an operation target, requesting, in a case where it is determined that the elapsed time is greater than or equal to a predetermined threshold, a server to search for relevant information relevant to the displayed content, and displaying the relevant information searched and retrieved according to the request.

### BACKGROUND

Field

The present disclosure relates to an information processing apparatus, an information processing method, and a computer-readable storage medium for displaying content relevant information.

Description of the Related Art

There is a case where a user displays content such as a report or a proposal document on a display screen by using an application and reviews the content. In consideration of such a case, there is provided a system for displaying a file relevant to the content, such as a data analysis file used for preparing a proposal document, together with the content, which enables a user to efficiently review the content.

When a user searches for a file relevant to the content displayed on a screen, as one method, the user can use a keyword extracted from the contents of the content to find out a desired file using a file storage search function. However, with the above-described method, the user cannot perform the work efficiently since it will take time to find out a desired file from a search result.

In an information processing system discussed in Japanese Patent Application Laid-Open No. 2014-219753, in response to a request from a client apparatus received via a network, a server apparatus searches for information relevant to a displayed document and transmits a response to the client apparatus. However, when the information processing system is used in such a situation where a large-sized display screen is touched and operated by a plurality of users at a conference and an application screen for displaying the content is switched frequently or the application screen is switched and displayed erroneously, the following issue can arise. Specifically, in the information processing system, a search system is overloaded since search of a relevant file is executed every time the application screen is switched, and thus a response speed is reduced when a relevant file is to be displayed.

### SUMMARY

According to aspects of embodiments, an information processing apparatus includes at least one processor and a computer-readable medium that stores computer executable instructions, which when executed by the at least one processor causes first determining whether elapsed time is greater than or equal to a predetermined threshold, wherein the elapsed time is time after a first application that displays content is selected as an operation target, requesting, in a case where the first determining determines that the elapsed time is greater than or equal to a predetermined threshold, a server to search for and retrieve relevant information relevant to the displayed content, and displaying the relevant information searched and retrieved according to the request.

Further features will become apparent from the following description of exemplary embodiments with reference to the attached drawings.

### BRIEF DESCRIPTION OF THE DRAWINGS

FIG. 1 is a diagram illustrating a configuration of an information processing system.

FIG. 2 is a block diagram illustrating an example of a hardware configuration of a client apparatus.

FIG. 3 is a block diagram illustrating an example of a hardware configuration of an analysis server and a file server.

FIG. 4 is a block diagram illustrating an example of a functional configuration of the analysis server.

FIG. 5 is a block diagram illustrating an example of a functional configuration of the file server.

FIG. 6 is a block diagram illustrating an example of a functional configuration of the client apparatus.

FIG. 7 is a diagram illustrating an example of a screen displayed by a relevant file display application.

FIG. 8 is a sequence diagram illustrating processing for displaying a relevant file.

FIG. 9 is a flowchart illustrating processing for acquiring content information.

FIG. 10 is a flowchart illustrating processing for displaying a relevant file.

FIG. 11 is a table illustrating an example of analysis result information.

FIG. 12 is a table illustrating an example of analysis result information.

FIG. 13 is a flowchart illustrating an example of processing for updating analysis result information.

### DESCRIPTION OF THE EMBODIMENTS

Various exemplary embodiments, features, and aspects will be described in detail below with reference to the drawings.

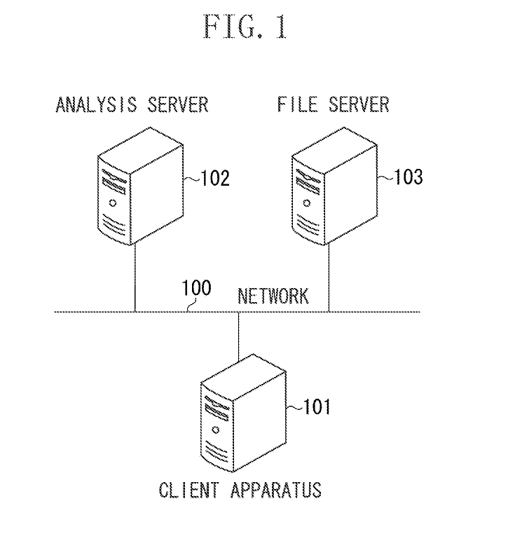

FIG. 1 is a diagram illustrating a configuration of an information processing system according to a first exemplary embodiment.

An information processing system illustrated in FIG. 1 includes a client apparatus 101, an analysis server 102, and a file server 103 connected to each other via a network 100. The network 100 serves as an infrastructure that allows respective devices to communicate with each other, and an intranet, the internet, or other network system can be used as the network 100.

The client apparatus 101 can be managed by a local internet protocol (IP) address. In this case, a gateway (not illustrated) provided between the network 100 and the client apparatus 101 executes conversion of the address. For example, a router is included in the gateway. The gateway or the client apparatus 101 can include a firewall function.

The analysis server 102 has a function of acquiring a file stored in the file server 103 and extracting and storing text in a database (DB). The analysis server 102 includes a function of comparing text by extracting the text from the information stored in the DB and electronic data as a comparison target, and listing candidates of storage destinations where files similar to the electronic data are stored. The file server 103 has a function of storing files.

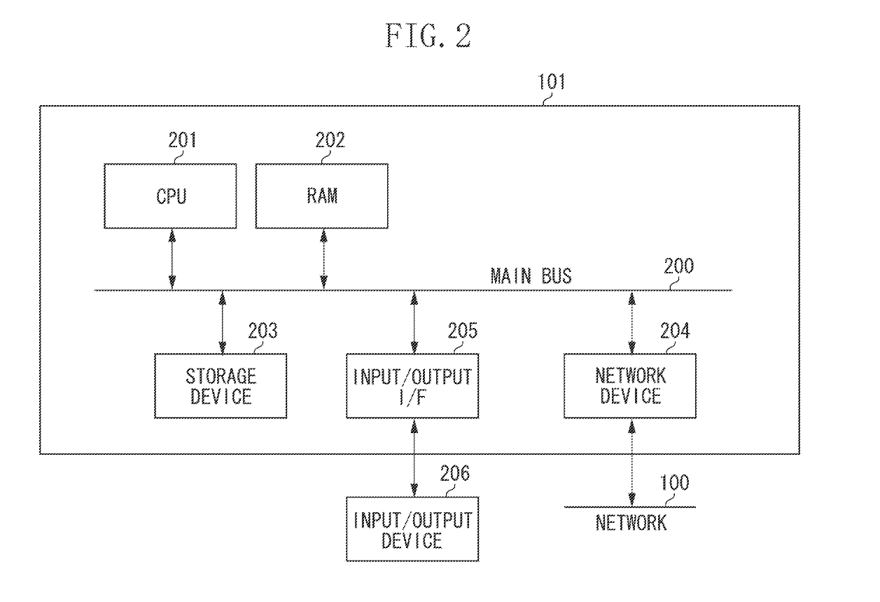

FIG. 2 is a block diagram illustrating an example of a hardware configuration of the client apparatus 101.

The client apparatus 101 includes respective units of a central processing unit (CPU) 201, a random access memory (RAM) 202, a storage device 203, a network device 204, an input/output interface (I/F) 205, and an input/output device 206. The CPU 201 controls the entirety of the client apparatus 101. The RAM 202 provides a work area of the CPU 201. The storage device 203 stores a program operating on the client apparatus 101 and settings.

The network device 204 executes communication with other devices through the network 100. The input/output I/F 205 receives the information input from the input/output device 206, and transmits information to be output from the input/output device 206 to the input/output device 206.

For example, the input/output I/F 205 includes a PS2 port, a universal serial bus (USB) I/F, and an analog or digital display I/F. The input/output device 206 is a keyboard, a mouse, a cathode-ray tube (CRT) display, or a liquid crystal display, which is connectable to the client apparatus 101 via the input/output I/F 205. In the present exemplary embodiment, unless otherwise specified, the CPU 201 realizes the functions of the client apparatus 101 by controlling the RAM 202, the storage device 203, the network device 204, and the input/output I/F 205 via a main bus 200.

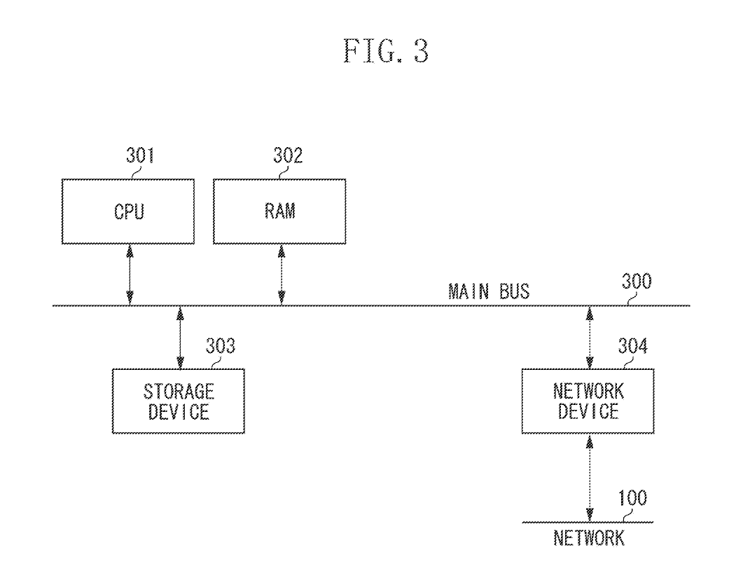

FIG. 3 is a block diagram illustrating an example of a hardware configuration of the analysis server 102 and the file server 103.

A server apparatus illustrated in FIG. 3 includes respective units of a CPU 301, a RAM 302, a storage device 303, and a network device 304. The CPU 301 controls the entirety of the server apparatus. The RAM 302 provides a work area of the CPU 301. The storage device 303 stores a program operating on the server apparatus and settings, and the network device 304 executes communication with other devices through the network 100. In the present exemplary embodiment, unless otherwise specified, the CPU 301 realizes the functions of the server apparatus by controlling the RAM 302, the storage device 303, and the network device 304 via a main bus 300.

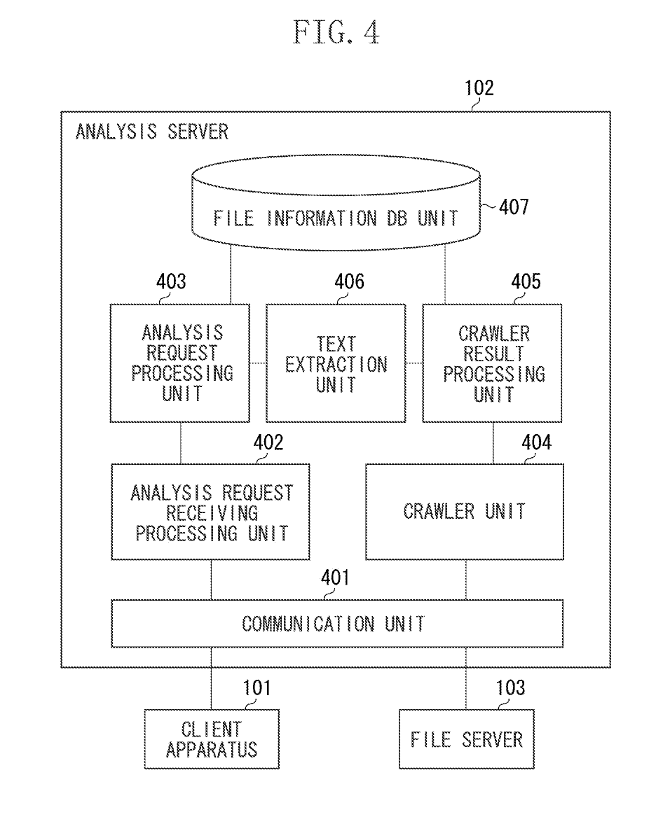

FIG. 4 is a block diagram illustrating an example of a functional configuration of the analysis server 102.

The CPU 301 included in the analysis server 102 executes a control program to realize each of the function units illustrated in FIG. 4. The analysis server 102 includes a communication unit 401, an analysis request receiving processing unit 402, an analysis request processing unit 403, a crawler unit 404, a crawler result processing unit 405, a text extraction unit 406, and a file information DB unit 407.

The crawler unit 404 periodically collects files (electronic data) stored in the file server 103 and storage destination information thereof via the communication unit 401. The crawler unit 404 collects a new file or an updated file. The crawler unit 404 does not collect a file collected already. The crawler unit 404 transmits the collected files and the storage destination information to the crawler result processing unit 405.

The crawler result processing unit 405 transmits the files received from the crawler unit 404 to the text extraction unit 406, and receives a text extraction result (feature information of the file) extracted from each of the files as a response. Then, the crawler result processing unit 405 stores the storage destination information corresponding to the text extraction result received from the text extraction unit 406 in the file information DB unit 407.

The analysis request receiving processing unit 402 receives an analysis request from the client apparatus 101 via the communication unit 401. An analysis target file is included in the analysis request. The analysis request receiving processing unit 402 transmits a result of analysis processed by the analysis request processing unit 403 according to the analysis request to the client apparatus 101 as a response. In this example, the client apparatus 101 transmits a search request of the information relevant to the content displayed by a content display application 605 to the analysis server 102 as an analysis request. Accordingly, the analysis request processing unit 403 searches for the information relevant to the content according to the search request. In response to the search request, the analysis request receiving processing unit 402 transmits the information relevant to the content searched and retrieved by the analysis request processing unit 403 to the client apparatus 101 as a search result.

The analysis request processing unit 403 transmits the analysis target file (e.g., search target file) received by the analysis request receiving processing unit 402 to the text extraction unit 406. Then, the analysis request processing unit 403 receives a text extraction result (i.e., feature information of the analysis target file) extracted from the analysis target file from the text extraction unit 406 as a response. The analysis request processing unit 403 acquires the feature information of the file from the file information DB unit 407, and executes comparison processing for comparing the feature information of the file with the text extraction result of the analysis target file received from the text extraction unit 406. As a result of the comparison, the analysis request processing unit 403 transmits file information similar to the received analysis target file to the analysis request receiving processing unit 402 as an analysis result. The analysis request processing unit 403 executes processing for changing the analysis result of the similar file information based on the similarity between the received analysis target file and the similar file.

The text extraction unit 406 executes processing for extracting text information from a file. The text extraction unit 406 can execute processing for dividing the extracted text into proper segments, counting the number of appearances of a keyword, and analyzing a layout of text or a figure, so as to output these processing results as the feature information of the file. The text extraction unit 406 can transmit the text extracted from the file to the crawler result processing unit 405 or the analysis request processing unit 403 as it is as a feature information of the file. Alternatively, the text extraction unit 406 can transmit the analysis result of the text or the layout within the file as the feature information of the file.

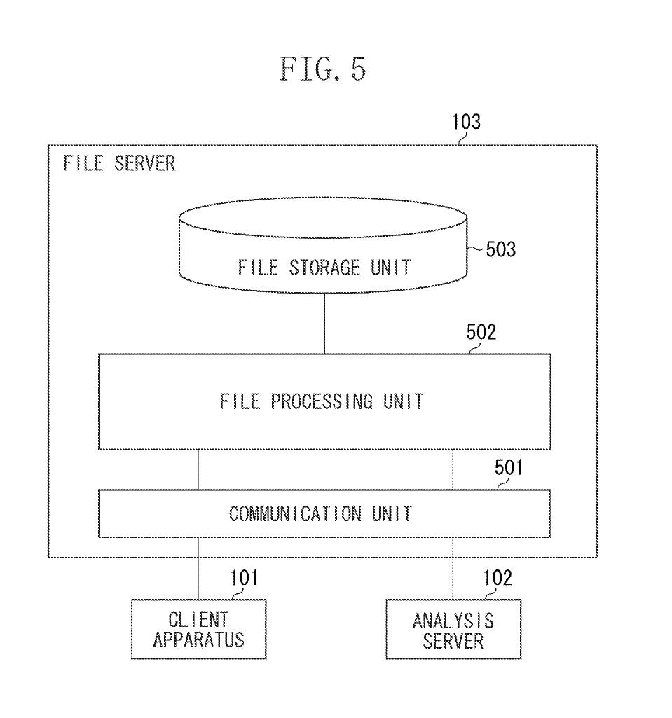

FIG. 5 is a block diagram illustrating an example of a functional configuration of the file server 103.

Each of the function units illustrated in FIG. 5 is realized by the CPU 301, which is included in the file server 103, executing a control program. The file server 103 includes a communication unit 501, a file processing unit 502, and a file storage unit 503.

The file processing unit 502 receives a request from the client apparatus 101 or the analysis server 102 via the communication unit 501. A type of the request received by the file processing unit 502 can be a request for storing a file in the file storage unit 503 or a request for acquiring a file stored in the file storage unit 503. The file processing unit 502 stores or acquires a file in/from the file storage unit 503 according to the received request. The file storage unit 503 stores an entity of the file according to the instruction from the file processing unit 502.

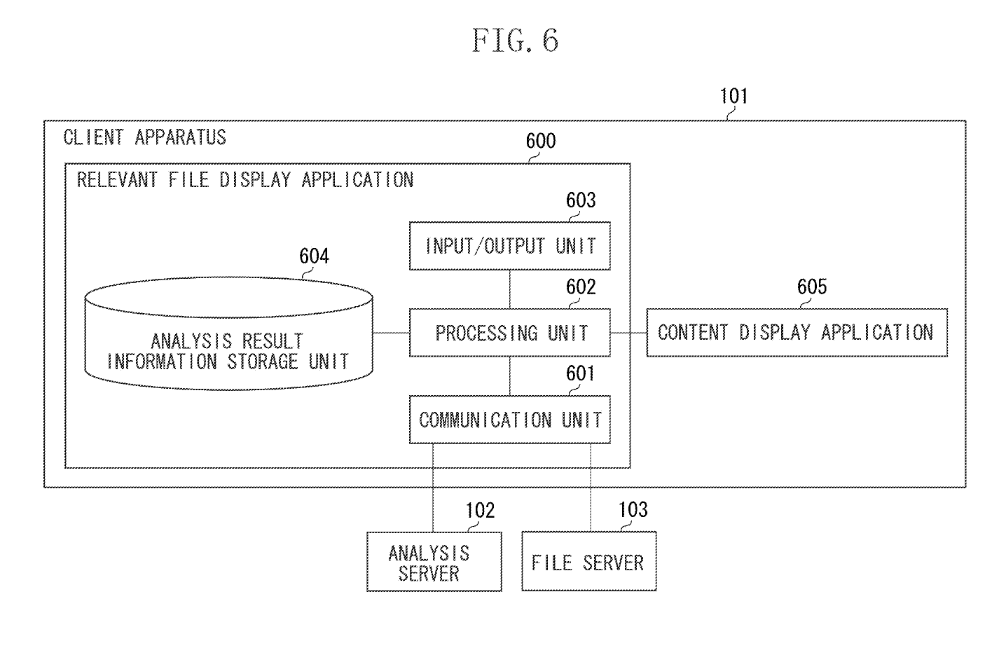

FIG. 6 is a block diagram illustrating an example of a functional configuration of the client apparatus 101.

The client apparatus 101 includes a relevant file display application 600 and a content display application 605.

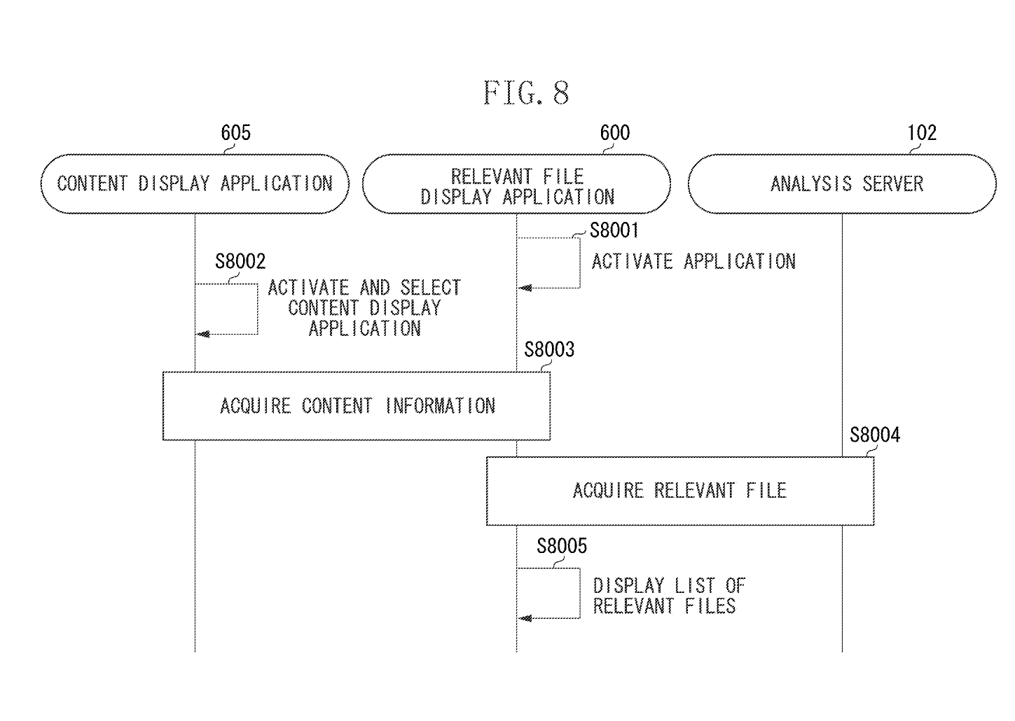

The relevant file display application 600 and the content display application 605 are stored in the storage device 203 and executed by the CPU 201 included in the client apparatus 101. The relevant file display application 600 includes a communication unit 601, a processing unit 602, an input/output unit 603, and an analysis result information storage unit 604. The processing unit 602 executes communication with the analysis server 102 and the file server 103 via the communication unit 601. In addition, a series of processing sequences mainly executed by the processing unit 602 will be described below with reference to FIG. 8.

The content display application 605 is a first display unit that is selected by a user on an operation screen to display content on a screen. The relevant file display application 600 acquires content information from the content display application 605 via the input/output unit 603. Content of an application regarded as an input/operation target of the user is an acquisition target content. In the Windows operating system (OS), a state where the application is specified as an input/operation target of the user is referred to as “active”.

The processing unit 602 transmits the acquired content information to the analysis server 102 and requests analysis of the content via the communication unit 601. In response to the analysis request, the processing unit 602 receives an analysis result via the communication unit 601. The analysis result is a file (relevant file) of relevant information that is relevant (similar) to the content information. The processing unit 602 stores the analysis result information including the received analysis result in the analysis result information storage unit 604, and executes processing for displaying a screen of a relevant file list on the input/output unit 603. In other words, the processing unit 602 acquires content information such as a name or contents of the content from the content display application 605 selected by the user, transmits the content information to the analysis server 102, and displays relevant file information included in the received response.

The processing unit 602 determines whether the analysis result of the content information acquired from the content display application 605 is already stored in the analysis result information storage unit 604. If the analysis result of the content information acquired from the content display application 605 is already stored in the analysis result information storage unit 604, the processing unit 602 functions as a second display unit that displays the stored analysis result on the input/output unit 603. If the analysis result of the content information acquired from the content display application 605 is not stored in the analysis result information storage unit 604, the processing unit 602 functions as a first request unit that transmits an analysis request of the content to the analysis server 102 via the network 100. When the user inputs a download request of the relevant file displayed as the analysis result through the input/output unit 603, the processing unit 602 downloads the file from the file server 103 via the communication unit 601.

The input/output unit 603 executes processing for displaying a screen to the user via the input/output device 206. The input/output unit 603 detects a selection event of the content display application 605, and executes processing for acquiring the content information of the selected content display application 605. The analysis result information storage unit 604 serves as a storage unit for storing analysis result information. More specifically, the processing unit 602 stores the content displayed by the content display application 605 and the analysis result corresponding to the information relevant to that content in the analysis result information storage unit 604 in association with each other as the analysis result information.

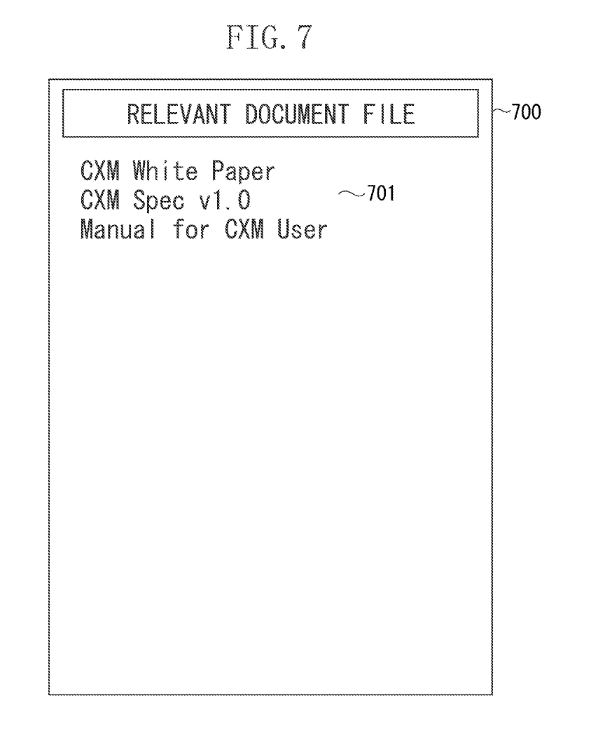

FIG. 7 is a diagram illustrating an example of a screen displayed by the relevant file display application 600.

A relevant file that is provided through the analysis processing executed by the analysis server 102 according to the analysis request from the client apparatus 101 is displayed in a display area 701 of a screen 700 in FIG. 7.

FIG. 8 is a diagram illustrating a sequence of processing for displaying the relevant file.

First, in step S8001, according to the operation of the user, the relevant file display application 600 is activated, and displays the screen 700 in FIG. 7 on the input/output device 206. In step S8002, according to the operation of the user, the content display application 606 is activated and selected in the input/output device 206.

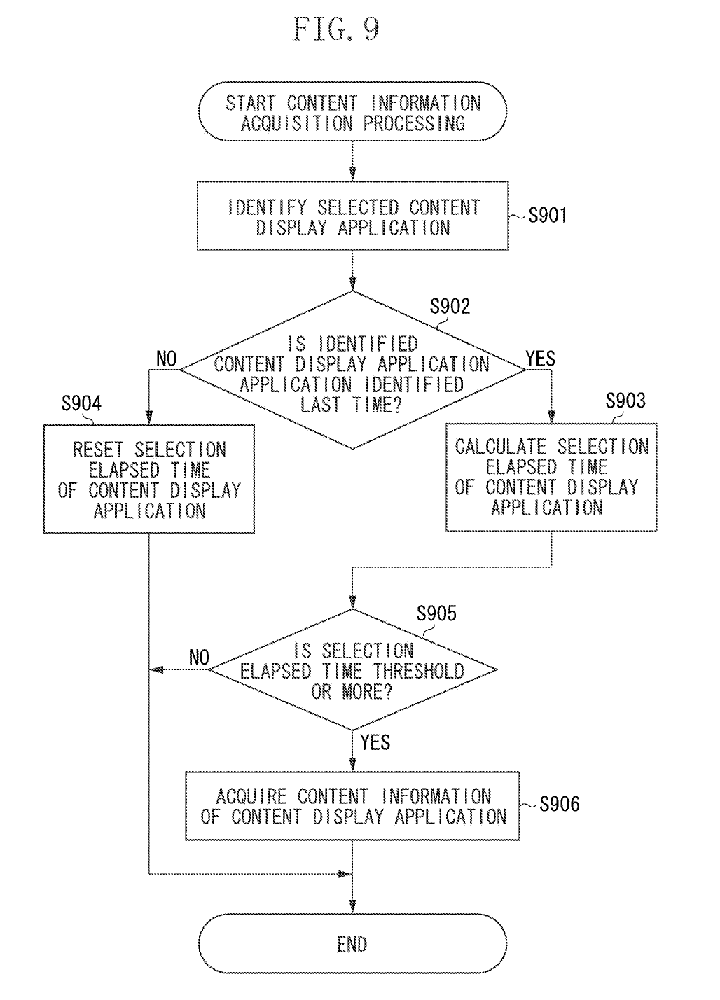

Next, in step S8003, the relevant file display application 600 identifies the selected content display application 605 and acquires the content information of the identified content display application 605. The processing in step S8003 will be described specifically with reference to the flowchart in FIG. 9.

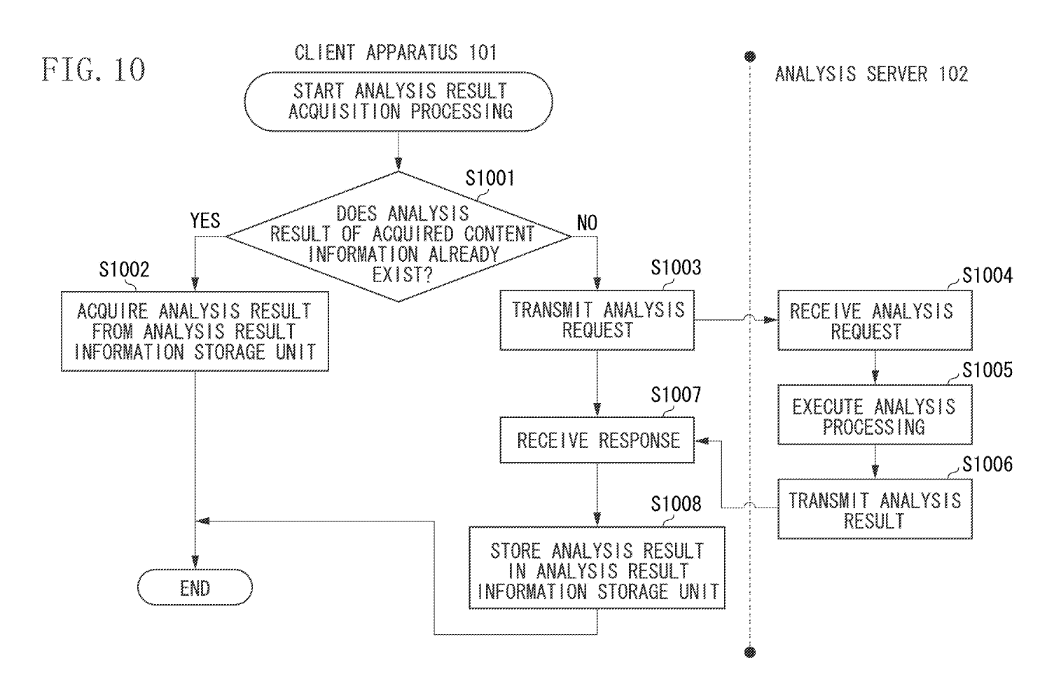

In step S8004, the relevant file display application 600 transmits an analysis request of the content information to the analysis server 102 and acquires a relevant file as an analysis result. The processing in step S8005 will be described specifically with reference to the flowchart in FIG. 10. Then, in step S8005, the relevant file display application 600 displays a list of acquired relevant files on a screen.

FIG. 9 is a flowchart illustrating processing for acquiring the content information of the content display application 605.

The processing illustrated in FIG. 9 is executed constantly and continuously. In step S901, the processing unit 602 of the relevant file display application 600 identifies the selected content display application 605 via the input/output unit 603. For example, the processing unit 602 identifies the selected content display application 605 based on a content display application name, a content name, and a content type.

In step S902, the processing unit 602 determines whether the identified content display application 605 is the application identified last time. If the identified content display application 605 is not the application identified last time (NO in step S902), the processing proceeds to step S904. Then, in step S904, the processing unit 602 resets a selection elapsed time of the content display application 605 by setting the time to 0-second, for example, and ends the processing.

If the identified content display application 605 is the application identified last time (YES in step S902), the processing proceeds to step S903. In step S903, the processing unit 602 calculates the selection elapsed time of the identified selected content display application 605. For example, the processing unit 602 stores a total value of “selection elapsed time” and “difference between identification date/time and last identification date/time” calculated last time in the storage device 203 together with the content information. Then, the processing unit 602 calculates the selection elapsed time of this time based on the value stored in the storage device 203.

Next, in step S905, the processing unit 602 determines whether the selection elapsed time is a threshold or more. A default value can be used as the threshold, or the user can set the threshold at the setting screen of the relevant file display application 600. If the selection elapsed time is less than the threshold (NO in step S905), the processing is ended. If the selection elapsed time is the threshold or more (YES in step S905), the processing proceeds to step S906. In step S906, the processing unit 602 acquires the content information of the selected content display application 605 via the input/output unit 603, and ends the processing. The content information includes at least any one of a name of the content, contents of the content, and address information of the content. The address information of the content can be a pass or a uniform resource locator (URL) that indicates a content destination.

FIG. 10 is a flowchart illustrating processing for causing the relevant file display application 600 to display a relevant file relevant to the content displayed by the content display application 605.

The processing described with reference to FIG. 10 corresponds to the processing in step S8004 of FIG. 8. In step S1001, the processing unit 602 of the relevant file display application 600 searches and retrieves the analysis result (relevant file) relevant to the acquired content information and determines whether the analysis result is stored in the analysis result information storage unit 604.

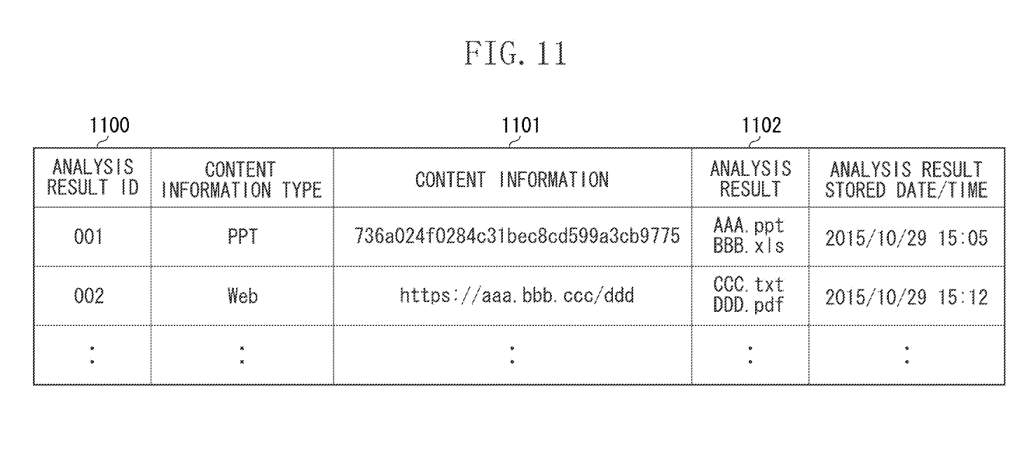

FIG. 11 is a table illustrating an example of the analysis result information stored in the analysis result information storage unit 604.

Analysis result information 1100 includes an analysis result identification (ID), a content information type, content information 1101, an analysis result 1102, and an analysis result stored date/time.

The processing in step S1001 in FIG. 10 will be described specifically. The processing unit 602 searches the analysis result information storage unit 604 and determines whether the acquired content information exists in the content information 1101 within the analysis result information 1100 stored in the analysis result information storage unit 604. The analysis result information 1100 can take a configuration in which a value of the content information 1101 is changed according to the content type such as a hash value or a URL. If the analysis result information 1100 takes the above configuration, the processing unit 602 uses the content information converted into a hash value or a URL format to search the analysis result information storage unit 604.

If the analysis result relevant to the acquired content information is stored in the analysis result information storage unit 604 (YES in step S1001), the processing proceeds to step S1002. In step S1002, the processing unit 602 acquires the analysis result relevant to the content information from the analysis result information storage unit 604 and ends the processing. In other words, the processing unit 602 acquires a relevant file from the analysis result 1102 stored in the analysis result information 1100 in association with the content information 1101. The acquired relevant file is displayed on the screen in step S805 of FIG. 8. In addition, when the user closes or ends the content display application 605, the processing unit 602 can delete the analysis result information corresponding to the content information displayed by the content display application 605.

If the analysis result relevant to the acquired content information is not stored in the analysis result information storage unit 604 (NO in step S1001), the processing proceeds to step S1003. In step S1003, the processing unit 602 transmits a file of the content information to the analysis server 102 together with the analysis request via the communication unit 601.

In step S1004, the analysis request receiving processing unit 402 of the analysis server 102 receives the analysis request. Subsequently, the analysis request processing unit 403 acquires a file (relevant file) similar to the file of the received content information as the analysis result. In step S1006, the analysis request processing unit 403 transmits the analysis result to the client apparatus 101 as a response via the analysis request receiving processing unit 402.

In step S1007, the processing unit 602 of the relevant file display application 600 receives the analysis result via the communication unit 601. In step S1008, the processing unit 602 stores the analysis result information in the analysis result information storage unit 604 in association with the content and ends the processing.

The information processing system of the present exemplary embodiment searches for the information relevant to the displayed content when a predetermined time has passed after the content display application 605 is selected. In other words, the information processing system does not instantly search for the relevant information of the content even if the content display application 605 is selected erroneously. Accordingly, it is possible to reduce a useless load of a search system with respect to the search processing of the relevant information.

When the analysis result of the content information already exists in the analysis result information storage unit 604, the relevant file display application 600 displays that analysis result (relevant file) on the screen. However, when the analysis server 102 updates the information stored in the file information DB unit 407, the analysis result of the content information can be changed. Because the analysis result stored in the analysis result information storage unit 604 of the client apparatus 101 is not changed, unconformity can arise in the analysis result. Accordingly, in a second exemplary embodiment, the client apparatus 101 automatically updates the analysis result information stored in the analysis result information storage unit 604 according to passage of update time of the information stored in the file information DB unit 407 of the analysis server 102.

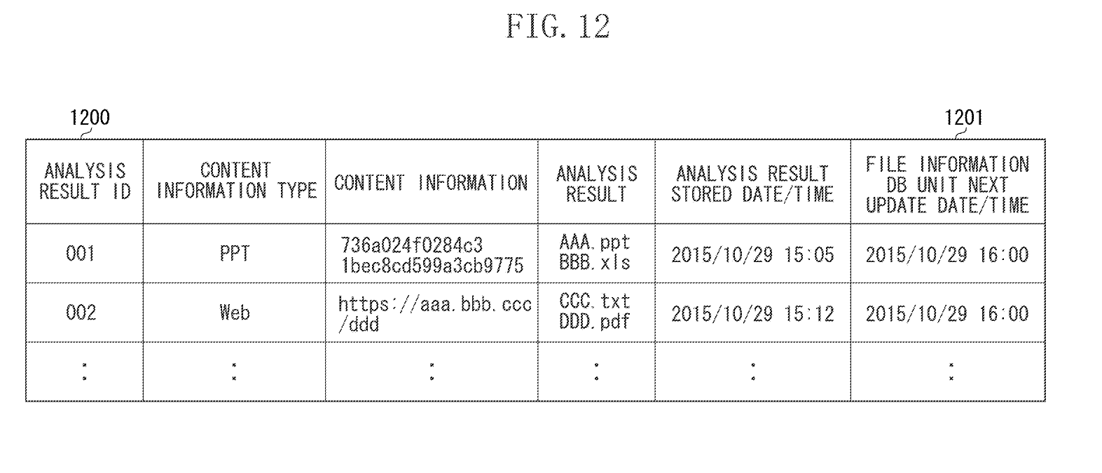

FIG. 12 is a table illustrating an example of analysis result information stored in an analysis result information storage unit 604 in the present exemplary embodiment.

The analysis result information illustrated in FIG. 12 is different from the analysis result information in the first exemplary embodiment illustrated in FIG. 11 in that a file information DB unit next update date/time 1201 is stored as additional information. The file information DB unit next update date/time 1201 indicates next update date/time information (update time) at which the analysis server 102 executes processing for collecting files and storage destination information of the file server 103 and updating the information stored in the file information DB unit 407. In other words, in the present exemplary embodiment, information about the update time of the information which the analysis server 102 uses for search processing according to an analysis request (search request) is stored in association with the information relevant to the content. The information used for the search processing according to the search request is a file which the analysis server 102 periodically acquires from the file server 103 as an external apparatus. The client apparatus 101 receives the update time set to the file information DB unit next update date/time 1201 from the analysis server 102 together with the analysis result transmitted therefrom.

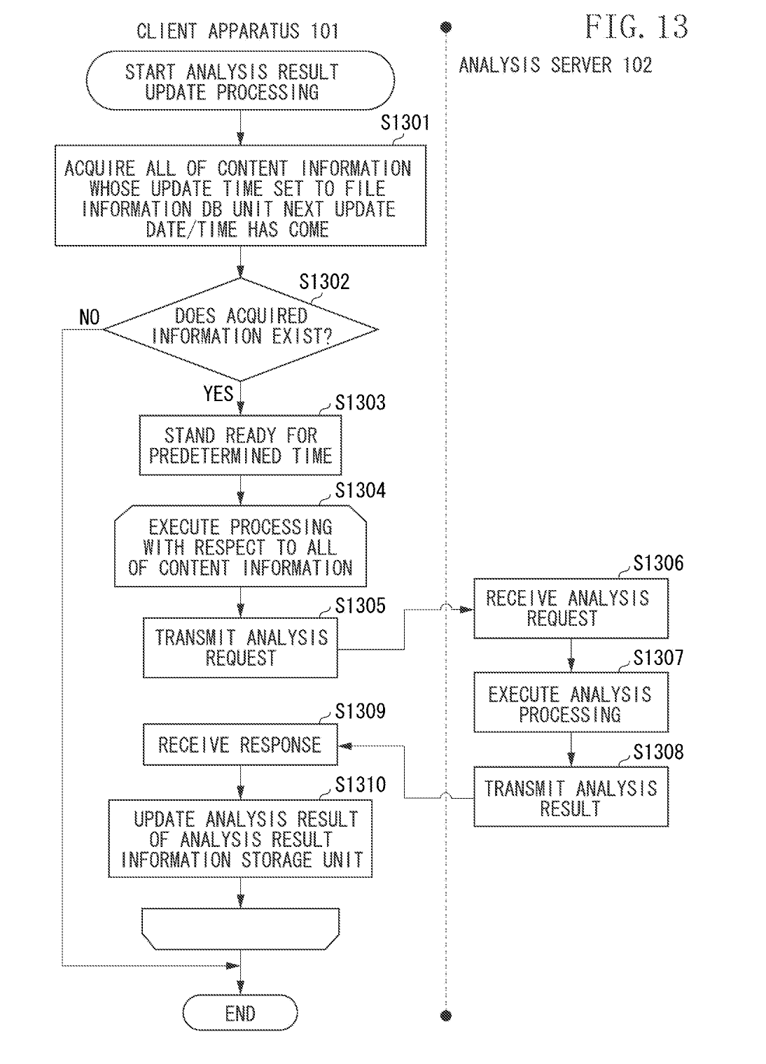

FIG. 13 is a flowchart illustrating an example of update processing of the analysis result information stored in the analysis result information storage unit 604.

In step S1301, the processing unit 602 acquires content information from a record (one-row worth of data) whose update time set to the file information DB unit next date/time 1201 has come.

In step S1302, the processing unit 602 determines whether the content information acquired from the record whose update time has come exists. If the content information acquired from the record whose update time has come does not exist (NO in step S1302), the processing is ended. If the content information acquired from the record whose update time has come exists (YES in step S1302), the processing proceeds to step S1303.

In step S1303, the processing unit 602 stands ready until a predetermined time has passed from the update time. By standing ready until the predetermined time has passed, the processing unit 602 can execute the processing in step S1304 and subsequent steps after the analysis server 102 ends the update processing of the information stored in the file information DB unit 407. A default value can be used as the stand-by time, or the user can set the stand-by time at the setting screen of the relevant file display application 600. The analysis server 102 can calculate the stand-by time based on the last update time and notify the client apparatus 101 of the stand-by time together with the analysis result as a response.

In step S1304, the processing unit 602 repeatedly executes the processing in steps S1305 to S1310 with respect to all of the content information acquired in step S1301. The processing in steps S1305 to S1309 is similar to the processing executed in steps S1003 to S1007 in FIG. 10, and thus description thereof will be omitted. In other words, in step S1305, the processing unit 602 functions as a second request unit that transmits a search request (analysis request) of information relevant to the content corresponding to the update time. In step S1310, the processing unit 602 updates the analysis result of the content information stored in the analysis result information storage unit 604 based on the analysis result received from the analysis server 102 in step S1309.

As described above, according to the present exemplary embodiment, the analysis result information stored in the analysis result information storage unit 604 of the client apparatus 101 can be automatically updated according to the update time of the information stored in the file information DB unit 407 of the analysis server 102.

### OTHER EMBODIMENTS

Embodiment(s) can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While exemplary embodiments have been described, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2016-012151, filed Jan. 26, 2016, which is hereby incorporated by reference herein in its entirety.

What is claimed is:

1. An information processing apparatus comprising:
at least one processor;
a computer-readable medium that stores computer executable instructions, which when executed by the at least one processor, causes:
first determining whether elapsed time is greater than or equal to a predetermined threshold, wherein the elapsed time is time after a first application that displays content is selected as an operation target;
requesting, in a case where the first determining determines that the elapsed time is greater than or equal to a predetermined threshold, a server to search for and retrieve relevant information relevant to the displayed content; and
displaying the relevant information searched and retrieved according to the request.

2. The information processing apparatus according to claim 1,
wherein the computer executable instructions, which when executed by the at least one processor, further causes second determining whether the relevant information relevant to the displayed content is previously stored in a storage of the information processing apparatus,
wherein, in a case where the first determining determines that the elapsed time is greater than or equal to the predetermined threshold and the second determining determines that the relevant information is not stored in the storage, the server is requested to search for the relevant information relevant to the displayed content, and the relevant information searched and retrieved by the server according to the request is displayed, and
wherein, in a case where the first determining determines that the elapsed time is greater than or equal to the predetermined threshold and the second determining determines that the relevant information is previously stored in the storage, the relevant information previously stored in the storage is displayed.

3. The information processing apparatus according to claim 2, further including storing the relevant information searched and retrieved according to the request in the storage.

4. The information processing apparatus according to claim 1, wherein, the server is requested to search for the relevant information relevant to the displayed content by using at least any one of a name of the displayed content, contents of the displayed content, or address information of the displayed content.

5. The information processing apparatus according to claim 1, wherein the server stores information, which is relevant to a file stored in a file server, in a database, and searches for the relevant information relevant to the content from among information stored in the database based on the request from the information processing apparatus.

6. The information processing apparatus according to claim 5, further including:
storing the relevant information searched and retrieved according to the request in the storage; and
updating the relevant information stored in the storage based on time at which the information stored in the database is updated by the server, and
wherein, in a case where the relevant information relevant to the displayed content is previously stored in the storage, the relevant information previously stored is displayed.

7. An information processing method executed by an apparatus, the information processing method comprising:
determining whether elapsed time is greater than or equal to a predetermined threshold, wherein the elapsed time is time after a first application that displays content is selected as an operation target;
requesting, in a case where it is determined that the elapsed time is greater than or equal to a predetermined threshold, a server to search for relevant information relevant to the displayed content; and
displaying the relevant information searched and retrieved according to the request.

8. The information processing method according to claim 7, further including: determining whether the relevant information relevant to the displayed content is previously stored in a storage of an information processing apparatus,
wherein, in a case where it is determined that the elapsed time is greater than or equal to the predetermined threshold and it is determined that the relevant information is not stored in the storage, the server is requested to search for the relevant information relevant to the displayed content, and the relevant information searched and retrieved by the server according to the request is displayed, and
wherein, in a case where it is determined that the elapsed time is greater than or equal to the predetermined threshold and it is determined that the relevant information is previously stored in the storage, the relevant information previously stored in the storage is displayed.

9. The information processing method according to claim 8, further including storing the relevant information searched and retrieved according to the request in the storage.

10. The information processing method according to claim 7, wherein, the server is requested to search for the relevant information relevant to the displayed content by using at least any one of a name of the displayed content, contents of the displayed content, or address information of the displayed content.

11. The information processing method according to claim 7, wherein the server stores information, which is relevant to a file stored in a file server, in a database, and searches for the relevant information relevant to the content from among information stored in the database based on the request.

12. The information processing method according to claim 11, further including:
storing the relevant information searched and retrieved according to the request in the storage; and
updating the relevant information stored in the storage based on time at which the information stored in the database is updated by the server, and
wherein, in a case where the relevant information relevant to the displayed content is previously stored in the storage, the relevant information previously stored is displayed.

13. A non-transitory computer-readable storage medium storing computer executable instructions that cause a computer to perform a method, the method comprising:
determining whether elapsed time is greater than or equal to a predetermined threshold, wherein the elapsed time is time after a first application that displays content is selected as an operation target;
requesting, in a case where it is determined that the elapsed time is greater than or equal to a predetermined threshold, a server to search for relevant information relevant to the displayed content; and
displaying the relevant information searched and retrieved according to the request.

14. The non-transitory computer-readable storage medium according to claim 13, wherein the method further includes determining whether the relevant information relevant to the displayed content is previously stored in a storage of an information processing apparatus,
wherein, in a case where it is determined that the elapsed time is greater than or equal to the predetermined threshold and it is determined that the relevant information is not stored in the storage, the server is requested to search for the relevant information relevant to the displayed content, and the relevant information searched and retrieved by the server according to the request is displayed, and
wherein, in a case where it is determined that the elapsed time is greater than or equal to the predetermined threshold and it is determined that the relevant information is previously stored in the storage, the relevant information previously stored in the storage is displayed.

15. The non-transitory computer-readable storage medium according to claim 14, wherein the method further includes storing the relevant information searched and retrieved according to the request in the storage.

16. The non-transitory computer-readable storage medium according to claim 13, wherein, the server is requested to search for the relevant information relevant to the displayed content by using at least any one of a name of the displayed content, contents of the displayed content, or address information of the displayed content.

17. The non-transitory computer-readable storage medium according to claim 13, wherein the server stores information, which is relevant to a file stored in a file server, in a database, and searches for the relevant information relevant to the content from among information stored in the database based on the request.

18. The non-transitory computer-readable storage medium according to claim 17, wherein the method further includes:
storing the relevant information searched and retrieved according to the request in the storage; and
updating the relevant information stored in the storage based on time at which the information stored in the database is updated by the server, and
wherein, in a case where the relevant information relevant to the displayed content is previously stored in the storage, the relevant information previously stored is displayed.
